(19) United States
(12) Patent Application Publication
(10) Pub. No.: US 2026/0323554 A1
(43) Pub. Date: Oct. 15, 2026

(54) RESOURCE SCHEDULING FOR CHANNEL CARRYING UPLINK WAKE UP SIGNAL CONFIGURATION FOR ON-DEMAND SI

(71) Applicant: QUALCOMM Incorporated, San Diego, CA (US)

(72) Inventor: Hung Dinh LY, San Diego, CA (US)

(21) Appl. No.: 19/177,310

(22) Filed: Apr. 11, 2025

(51) Int. Cl. H04W 56/00; H04W 72/232; H04W 76/40

(52) U.S. Cl. CPC H04W 56/002; H04W 72/232; H04W 76/40

(57) ABSTRACT

The apparatus may be a wireless device such as a UE that may be configured to receive an indication of a set of resources associated with an SSB and carrying configuration information regarding a procedure for requesting system information, receive, in the set of resources, the configuration information, and transmit, based on the configuration information, a request for the system information. In some examples, the apparatus may be a network device such as a base station that may be configured to transmit an indication of a set of resources associated with a SSB and carrying configuration information regarding a procedure for requesting system information, and transmit, in the set of resources, the configuration information.

### TECHNICAL FIELD

The present disclosure relates generally to communication systems, and more particularly, to wireless communication systems supporting on-demand SI procedure for network energy savings (NES).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology, such as 6G, among other examples. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) configured to receive an indication of a set of resources associated with a synchronization signal block (SSB) and carrying configuration information regarding a procedure for requesting system information, receive, in the set of resources, the configuration information, and transmit, based on the configuration information, a request for the system information.

In an aspect of the disclosure, a method, a computer-readable medium, and an apparatus are provided. The apparatus may be a network device such as a base station or cell configured to transmit an indication of a set of resources associated with a SSB and carrying configuration information regarding a procedure for requesting system information, and transmit, in the set of resources, the configuration information.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a call flow diagram illustrating aspects of wireless communication associated with a first cell associated with one or more NES cells in accordance with some aspects of the disclosure.

FIG. 5A illustrates an example channel BW and resources associated with a SSB within the example channel BW.

FIG. 5B illustrates a first example use of available resources within the set of resources of FIG. 5A to transmit configuration information regarding a procedure for requesting system information.

FIG. 6A illustrates a second example use of available resources within the set of resources of FIG. 5A to transmit configuration information regarding a procedure for requesting system information.

FIG. 6B illustrates that for an SSB beginning, or mapped to, the third symbol of the slot, the PDCCH resources may include 2 symbols.

FIG. 7 illustrates a method for indicating the resources used to transmit configuration information regarding a procedure for requesting system information.

FIG. 8 is a call flow diagram illustrating a method of wireless communication associated with a NES cell providing configuration for an OD-SIB1 request to a UE in accordance with some aspects of the disclosure.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

In some aspects of wireless communication, one or more cells may operate in a NES mode of operation. A cell in the NES mode of operation (which may be referred to as a NES cell), in some aspects, may not transmit system information (e.g., a first system information block (SIB1) or other system information (OSI)) periodically, and may instead transmit the system information (SI) on-demand, e.g., based on a request (which may be referred to as an uplink wake up signal (UL-WUS), on-demand OSI (OD-OSI) request, or OD-SIB1 request) for the on-demand SI from a wireless device. In some aspects, the configuration of the request for the on-demand SI (e.g., the SIB1 or OSI) may not be known to a wireless device attempting to establish a connection with the cell. The wireless device, in some aspects, may receive the configuration for the OD-SI request (or more generally for an OD-SI procedure) from a cell that is not operating in a NES mode of operation (which may be referred to as a cell A). The configuration information for the OD-SI procedure, in some aspects, may be referred to as, or include, an UL-WUS configuration and/or as UL-WUS configuration information.

When the UL-WUS configuration is received from a cell A, the process for a UE to connect to an NES cell may include obtaining the UL WUS configuration from a cell A, transmitting an UL WUS (or OD-SI request) on, or to, the NES cell, and receiving the on-demand SIB1 from the NES Cell. In some aspects, the UL WUS may be a physical random access channel (PRACH) transmission. Relying on another cell (e.g., a cell A) for providing the configuration of the request for the OD-SI (e.g., the UL-WUS configuration and/or the UL-WUS configuration information), in some aspects, may limit the deployment of NES cells. However, as the size of the configuration of the request for the OD-SI may not be small, providing the OD-SIB1 configuration from the NES cell and may reduce the energy savings associated with operating in the NES mode of operation. While the discussion below refers to an NES cell and OD-SIB1, the NES cell may be understood to represent (or be a shorthand for and/or be an example of) any cell that does not, or is not configured to, transmit SI periodically and OD-SIB1 may be understood to be an example of OD-SI to illustrate the concept. The concepts may be similarly applied for any OD-SI.

In some aspects, the cell may include the configuration information for the OD-SI (e.g., OD-SIB1 or OD-OSI) procedure in one of a master information block (MIB) transmitted via a physical broadcast channel (PBCH) associated with an SSB transmitted by the cell, downlink control information (DCI) transmitted via a physical downlink control channel (PDCCH) frequency division multiplexed (FDMed) with the SSB transmitted by the cell, or in a payload of a physical downlink shared channel (PDSCH) FDMed with the SSB transmitted by the cell. Additionally, in some aspects, carriers and/or channels having a wide bandwidth (BW) may accommodate, or allow for, the transmission of SI FDMed with the SSB transmitted by the cell.

Various aspects relate generally to solutions for on-demand SI for idle/inactive UEs. Some aspects relate to specifying procedures and signaling methods for UEs to obtain the configuration information for the OD-SI procedure (or the UL WUS configuration) from a cell and transmit the OD-SI request to the cell to receive the on-demand SI (e.g., on-demand SIB1 or other on-demand SI). Some aspects more specifically relate to resource scheduling for the channel carrying the configuration information for the OD-SIB1 procedure (or the UL WUS configuration). In some examples, a wireless device such as a UE may be configured to receive an indication of a set of resources associated with an SSB and carrying configuration information regarding a procedure for requesting system information, receive, in the set of resources, the configuration information, and transmit, based on the configuration information, a request for the system information. In some examples, a network device such as a base station may be configured to transmit an indication of a set of resources associated with a SSB and carrying configuration information regarding a procedure for requesting system information, and transmit, in the set of resources, the configuration information.

Particular aspects of the subject matter described in this disclosure can be implemented to realize one or more of the following potential advantages. In some examples, by providing configuration information regarding a procedure for requesting system information in an indicated set of resources associated with an SSB, the described techniques can be used to expand the deployment opportunities for NES cells and reduce, or eliminate, a dependence on a non-NES cell (e.g., a cell A).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems 6G systems, or other communication systems, may be arranged in multiple manners with various components or constituent parts. As an example, in a wireless communication network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

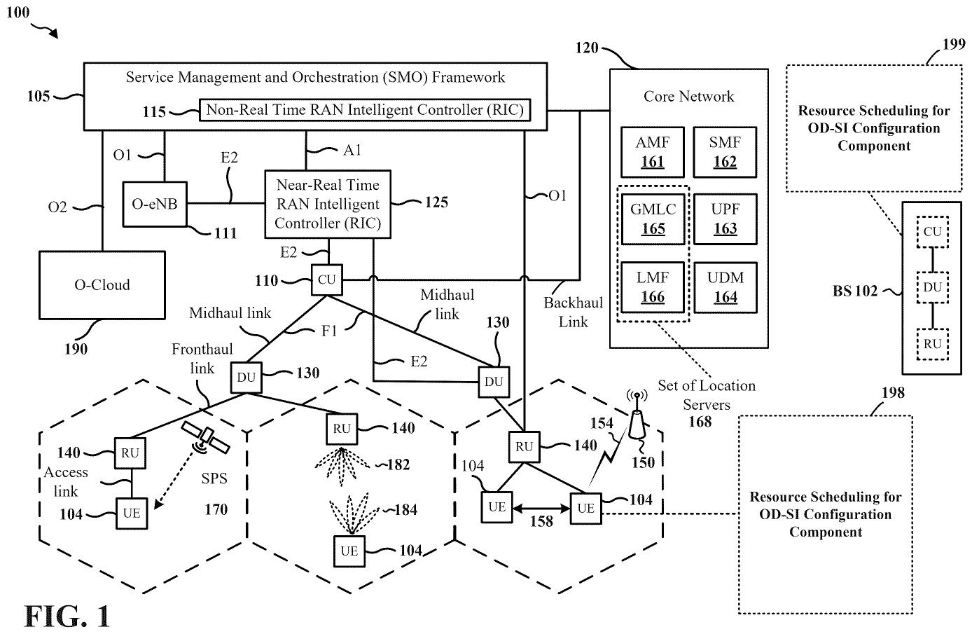

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. As an example, to illustrate the concept, in 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. An operating band for these mid-band frequencies may have the frequency range designation FR3 (7.125 GHZ-24.25 GHZ), for example. Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation, or other wireless communication operation, beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a resource scheduling for OD-SI configuration component 198 that may be configured to receive an indication of a set of resources associated with a SSB and carrying configuration information regarding a procedure for requesting system information, receive, in the set of resources, the configuration information, and transmit, based on the configuration information, a request for the system information. In certain aspects, the base station 102 may have a resource scheduling for OD-SI configuration component 199 that may be configured to transmit an indication of a set of resources associated with a SSB and carrying configuration information regarding a procedure for requesting system information, and transmit, in the set of resources, the configuration information. Although the following description may be focused on OD-SIB1, the concepts described herein may be applicable to other similar areas, such as OD-SI generally.

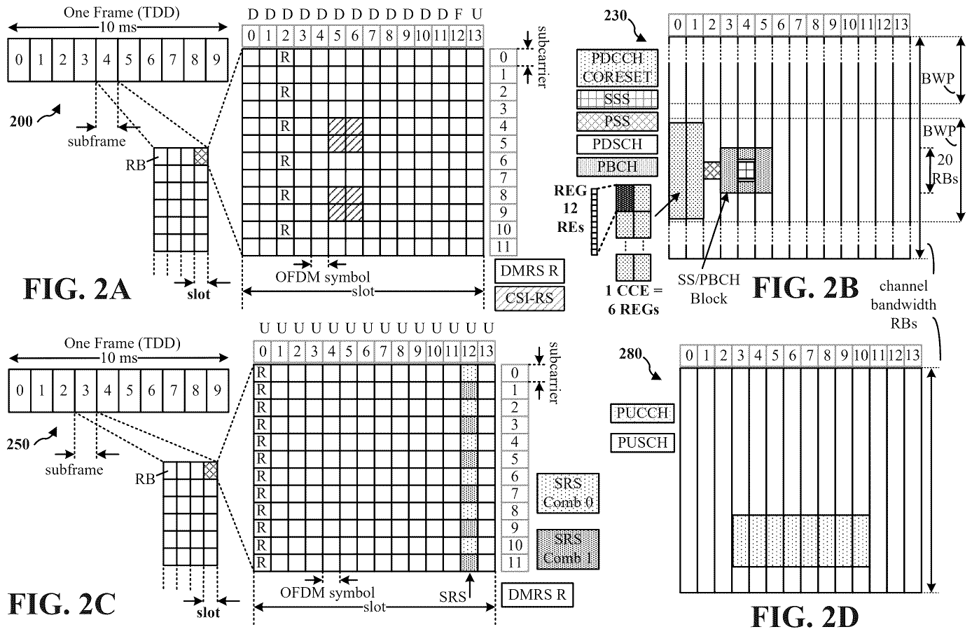

FIG. 2A is a diagram 200 illustrating an example of a first subframe within a 5G NR frame structure. The examples in FIGS. 2A-2D, illustrate aspects of a frame structure based on 5G NR to illustrate the concept of time and frequency resources based on a frame structure. Some aspects may be used in connection with other technology, such as 6G, for example. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 24*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

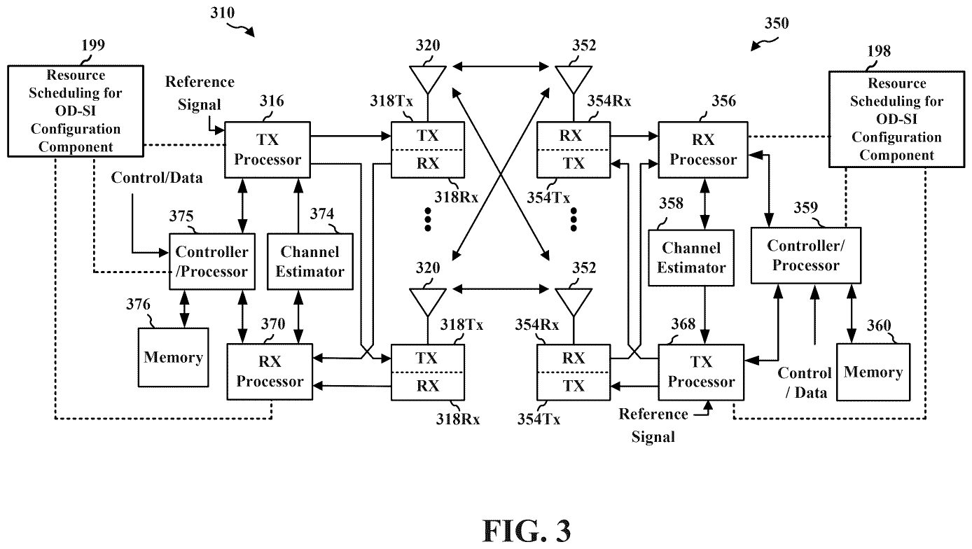

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the resource scheduling for OD-SI configuration component 198 of FIG. 1.

At least one of the TX processor 316, the RX processor 370, and the controller/processor 375 may be configured to perform aspects in connection with the resource scheduling for OD-SI configuration component 199 of FIG. 1.

In some aspects of wireless communication, one or more cells may operate in a NES mode of operation. A cell in the NES mode of operation (which may be referred to as a NES cell), in some aspects, may not transmit system information (e.g., a first system information block (SIB1) or other system information (OSI)) periodically, and may instead transmit the system information (SI) on-demand, e.g., based on or in response to a request (which may be referred to as an uplink wake up signal (UL-WUS) or OD-SI request) for the on-demand SI from a wireless device. In some aspects, the configuration of the request for the on-demand SI (e.g., the SIB1 or OSI) may not be known to a wireless device attempting to establish a connection with the cell. The wireless device, in some aspects, may receive the configuration for the OD-SI request (or more generally for an OD-SI procedure) from a cell that is not operating in a NES mode of operation (which may be referred to as a cell A). The configuration information for the OD-SI procedure, in some aspects, may be referred to as, or include, an UL-WUS configuration and/or as UL-WUS configuration information.

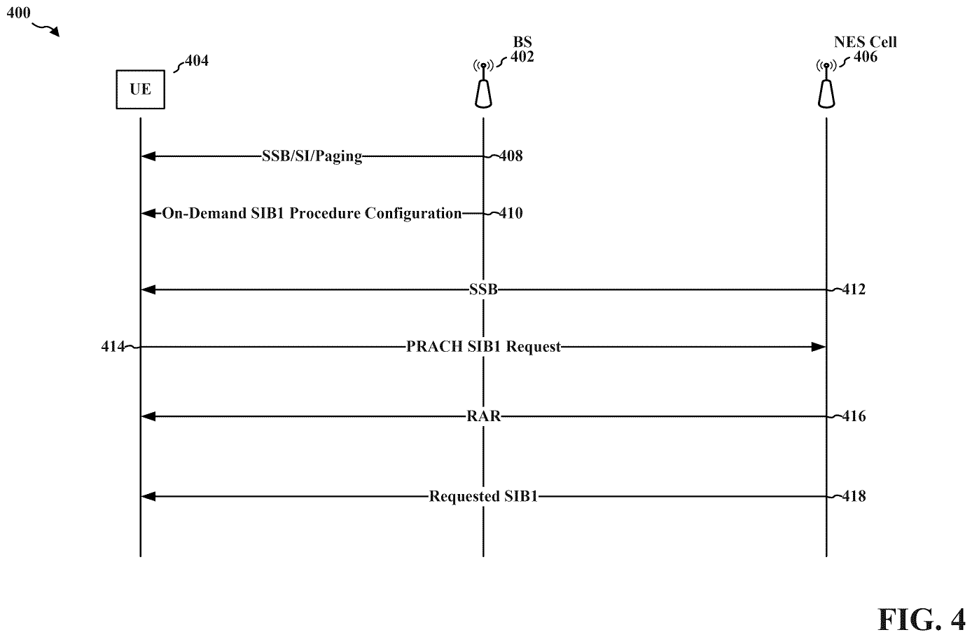

When the UL-WUS configuration is received from a cell A, the process for a UE to connect to an NES cell may include obtaining the UL WUS configuration from a cell A, transmitting an UL WUS (or OD-SI request) on, or to, the NES cell, and receiving the on-demand SI from the NES Cell. FIG. 4 is a call flow diagram 400 illustrating aspects of wireless communication associated with a first cell associated with one or more cells that support a NES mode (e.g., which may be referred to as NES cells) in accordance with some aspects of the disclosure. In some aspects, a first cell (e.g., a base station 402, that may be a non-NES cell or a cell that is not in an NES mode) may periodically transmit SSB, SI, and/or paging 408. A UE 404 may receive a configuration for an OD-SI request (e.g., UL-WUS configuration information for OD-SI from one or more NES cells, such as NES cell 406). For example, the UE 404 may receive the OD-SI procedure configuration 410 from the base station 402. The configuration information for an OD-SI, in some aspects, may be referred to as an UL-WUS configuration and/or as UL-WUS configuration information. In some aspects, the OD-SI may include or may correspond to an OD-SIB1. In some aspects, the OD-SI may include or correspond to other SI.

The NES cell 406, in some aspects, may transmit, and the UE 404 may receive SSB 412. If the UE 404 selects the NES cell 406 to camp on, the UE 404 may transmit a PRACH SIB1 request 414 (e.g., as an example of an OD-SI request to illustrate the concept) to NES cell 406 based on the OD-SI procedure configuration 410. The UE 404 may, in response to the PRACH SIB1 request 414, receive a random access response (RAR) 416 and the requested SI (e.g., SIB1 or OSI) 418. Based on the SI received from the NES cell 406, the UE 404 may transmit a PRACH message (e.g., a Msg1 or a MsgA of a RACH procedure, not shown) to establish a connection with the NES cell 406.

Relying on another cell (e.g., a cell A) for providing the configuration of the request for the OD-SI (e.g., the UL-WUS configuration and/or the UL-WUS configuration information), in some aspects, may limit the deployment of NES cells. However, as the size of the configuration of the request for the OD-SI may not be small (e.g., may include the information illustrated in Table 2), providing the OD-SI configuration from the NES cell and may reduce the energy savings associated with operating in the NES mode of operation.

TABLE 2
OD-SIB1 Configuration

| Aspects | Related RRC parameters |
|---|---|
| Frame structure | tdd-UL-DL-ConfigurationCommon |
| SSB | ssb-PositionsInBurst, ss-PBCH-BlockPower, |
| | rsrp-ThresholdSSB |
| UL BWP | locationAndBandwidth (location with |
| | respect to PointA) |
| UL frequency info | FDD/Supplementary UL (SUL): |
| | frequencyBand, absoluteFrequencyPointA |
| | p-Max, additionalSpectrumEmission |
| PRACH | prach-ConfigurationIndex |
| | msg1-FDM, msg1-FrequencyStart, ssb- |
| | perRACH-Occasion |
| | prach-RootSequenceIndex, |
| | zeroCorrelationZoneConfig, |
| | restrictedSetConfig, ra-PreambleIndex |
| | msg1-SubcarrierSpacing, |
| | preambleReceivedTargetPower, |
| | preambleTransMax, powerRampingStep |
| PDCCH | sib1-ResponseWindow |
| | controlResourceSetZero, searchSpaceSIB1 |

In some aspects, the cell may include the configuration information for the OD-SI (e.g., OD-SIB1 or OD-OSI) procedure in one of a MIB transmitted via a PBCH associated with an SSB transmitted by the cell, DCI transmitted via a PDCCH that is FDMed with the SSB transmitted by the cell, or in a payload of a PDSCH that is FDMed with the SSB transmitted by the cell. Additionally, in some aspects, carriers and/or channels having a wide BW may accommodate, or allow for, the transmission of SI FDMed with the SSB transmitted by the cell.

In some aspects, a minimum channel BW may be 24 RBs (at 15 kHz SCS in FR1 or 120 kHz SCS in FR2) and an SSB BW may be 20 RBs to enable sparse sync raster for reducing SSB cell search latency and/or power. Depending on the sync raster grid and the channel allocation, there could be available RBs in the SSB symbols within the channel BW. For example, there could be N_{rb,1} RBs below the first SSB RB (e.g., a lowest frequency RB used to transmit the SSB) and N_{rb,2} RBs above the last SSB RB (e.g., a highest frequency RB used to transmit the SSB). Based on the minimum channel BW of 24 RBs and the SSB BW of 20 RBs, the total number of RBs above and below the SSB in the channel BW will be at least four RBs (e.g., N_{rb,1}+N_{rb,2}≥4) and may be greater depending on the channel BW allocation. As discussed above, for carriers and/or channels that have a wide BW, it may be network-energy-efficient to support FDM of SSB and SIB1 where N_{rb,1}, N_{rb,2}, or N_{rb,1}+N_{rb,2} is large enough for SIB1 transmission such that no on-demand SIB1 is used. However, when the BW is not wide enough to support the FDM of SSB and SIB1 (e.g., for low frequency bands), the on-demand SIB1 may be used, and configuration information for the OD-SIB1 procedure may be provided.

Various aspects relate generally to solutions for on-demand SI (e.g., such as SIB1, OSI, or other SI) for idle/inactive UEs. Some aspects relate to specifying procedures and signaling methods for UEs to obtain the configuration information for the OD-SI procedure (or the UL WUS configuration) from a cell and transmit the OD-SIB1 request to the cell to receive the on-demand SI. Some aspects more specifically relate to resource scheduling for the channel carrying the configuration information for the OD-SI procedure (or the UL WUS configuration). In some examples, a wireless device such as a UE may be configured to receive an indication of a set of resources associated with an SSB and carrying configuration information regarding a procedure for requesting system information, receive, in the set of resources, the configuration information, and transmit, based on the configuration information, a request for the system information. In some examples, a network device such as a base station may be configured to transmit an indication of a set of resources associated with a SSB and carrying configuration information regarding a procedure for requesting system information, and transmit, in the set of resources, the configuration information.

Particular aspects of the subject matter described in this disclosure can be implemented to realize one or more of the following potential advantages. In some examples, by providing configuration information regarding a procedure for requesting system information in an indicated set of resources associated with an SSB, the described techniques can be used to expand the deployment opportunities for NES cells and reduce, or eliminate, a dependence on a non-NES cell (e.g., a cell A).

For a cell supporting OD-SI, the available resources within the channel BW and within an SSB time duration may be leveraged for transmitting the configuration information regarding a procedure for requesting system information (e.g., the configuration information for the OD-SI procedure or the UL WUS configuration). The available resources may be distributed below and above the SSB in the frequency domain, and the UE may not be aware of the distribution of the available resources. To use the resources, e.g., for transmitting/receiving the configuration information for the OD-SI procedure, the UE may receive an indication of resource scheduling for the available resources.

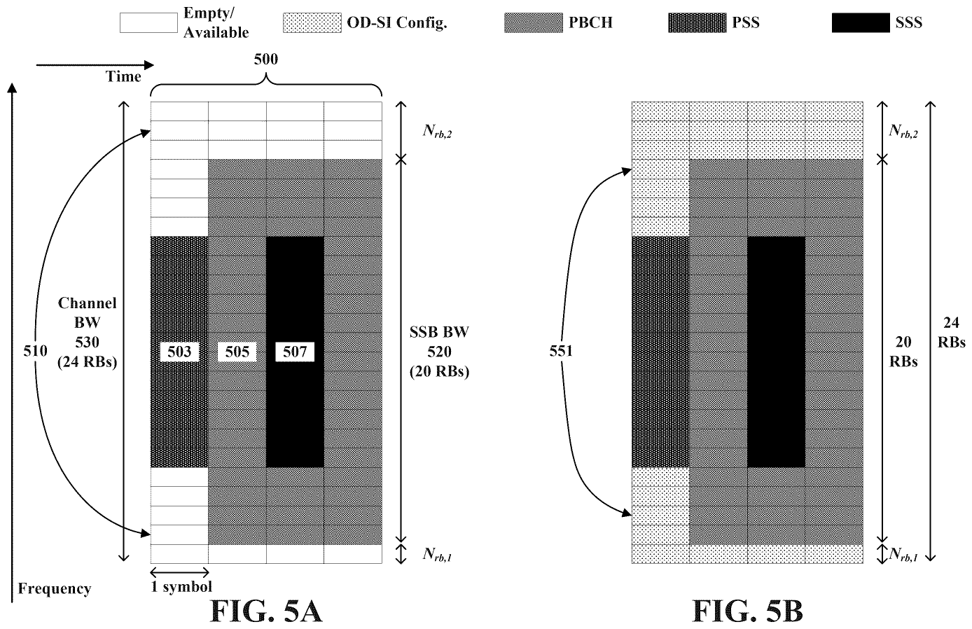

FIG. 5A illustrates an example channel BW and resources associated with a SSB within the example channel BW. FIG. 5A illustrates that a set of resources 500 including the frequency resources associated with a channel BW 530 (e.g., a minimum channel BW of 24 RBs) and spanning 4 symbols may be used to transmit an SSB within an SSB BW 520 (e.g., an SSB BW of 20 RBs). An SSB BW, in some aspects, may be expected to be fully overlapped with, or contained in, an associated channel BW as illustrated in relation to FIG. 5A.

As described in relation to FIG. 2B, the SSB may include a PSS 503, a PBCH 505, and an SSS 507. Within the set of resources 500, there may be available resources 510 (e.g., time-and-frequency resources or REs unused for the transmission of the SSB) that may be used for transmission of additional data. The available resources 510, in some aspects, may include N_{rb,1} RBs below the first SSB RB (e.g., a lowest frequency RB used to transmit the SSB) and N_{rb,2} RBs above the last SSB RB (e.g., a highest frequency RB used to transmit the SSB). Based on the minimum channel BW of 24 RBs and the SSB BW of 20 RBs, the total number of RBs above and below the SSB in the channel BW, for any channel, will be at least four RBs (e.g., N_{rb,1}+N_{rb,2≥4}) and may be greater depending on the channel BW allocation. For example, in FIG. 5A the minimum channel BW is illustrated such that N_{rb,1}+N_{rb,2}=4.

FIG. 5B illustrates a first example use of available resources 510 within the set of resources 500 of FIG. 5A to transmit configuration information regarding a procedure for requesting system information. FIG. 5B illustrates that the available resources 510 of FIG. 5A may be used to transmit OD-SI configuration information 551 (e.g., for OD-SIB1, OD-OSI, or other OD-SI). In some aspects, a new PHY channel may be transmitted in the available resources 510 to carry the OD-SI configuration information. The available resource 510 carrying the OD-SI configuration information 551, in some aspects, may include all the available resources 510 in the channel BW. For example, the OD-SI configuration information 551 may be carried, or included, in a first set of resources (REs) in the N_{rb,1} RBs below the SSB, a second set of resources (REs) in the N_{rb,2} RBs above the SSB, and a third set of resources within the SSB BW above and below the PSS.

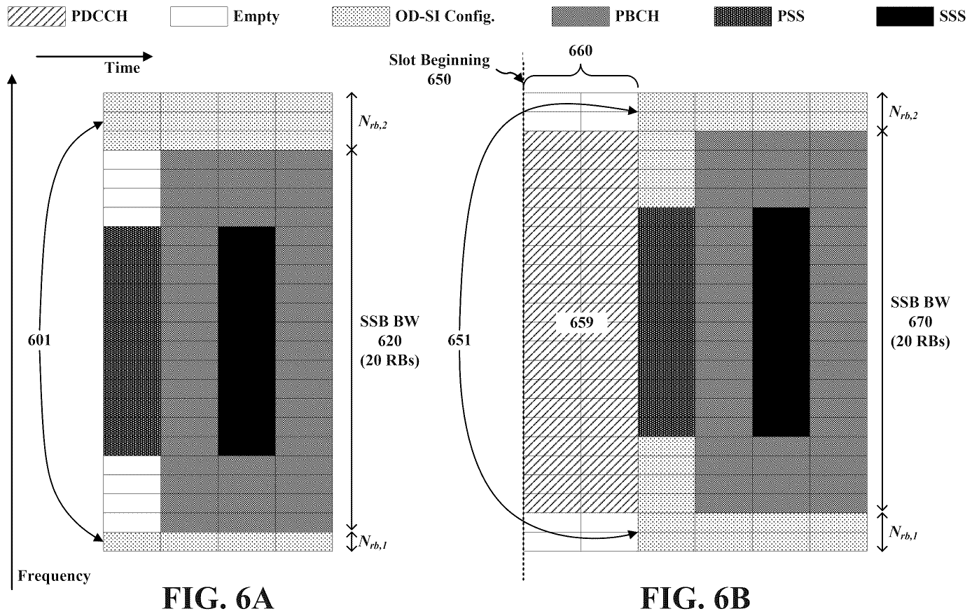

FIG. 6A illustrates a second example use of available resources 510 within the set of resources 500 of FIG. 5A to transmit configuration information regarding a procedure for requesting system information. FIG. 6A illustrates that the available resources 510 of FIG. 5A may be used to transmit OD-SI configuration information 601. The available resource 510 carrying the OD-SI configuration information 601, in some aspects, may include a subset of the available resources 510 in the channel BW. For example, the OD-SI configuration information 601 may be carried, or included, in a first set of resources (REs) in the N_{rb,1} RBs below the SSB, a second set of resources (REs) in the N_{rb,2} RBs above the SSB, but not carried, or included in, a third set of resources within the SSB BW 620 above and below the PSS (e.g., in a first symbol of the SSB).

FIG. 6B illustrates a first example PDCCH resource configuration for indicating the resources within the set of resources 500 of FIG. 5A used to transmit configuration information regarding a procedure for requesting system information. The first example PDCCH resource configuration for indicating the resources used to transmit configuration information regarding the procedure for requesting system information (e.g., PDCCH resources that may include a DCI providing resource scheduling for an OD-SI procedure configuration) may be known (or preconfigured) at the UE to include a first set of symbols 660 from the beginning of a slot (e.g., a slot beginning 650 of the slot containing the SSB) until, but not including, the first symbol of the SSB. For example, depending on the first symbol of the SSB within the slot, the PDCCH resources 659 based on the PDCCH resource configuration may include 1-3 symbols. FIG. 6B illustrates that for an SSB beginning, or mapped to, the third symbol of the slot, the PDCCH resources 659 may include 2 symbols. The frequencies (or RBs) associated with the PDCCH resources, in some aspects, may be the RBs associated with the SSB (e.g., the SSB BW 520 of FIG. 5A) as illustrated in FIG. 6B. While the SSB BW 670 may be used for the PDCCH resources 659 to limit the total number of RBs to monitor for the PDCCH and the SSB, other known frequency resource allocations may be used for the PDCCH resources 659 such as the channel BW, a subset of the channel BW, or a subset of the SSB BW. In some aspects, the periodicity of the PDCCH monitoring of the PDCCH resources 659 at the UE may be identical to (the same as) the periodicity of the SSB assumed for an initial cell selection.

The PDCCH resources 659 in some aspects, may include (or be used to transmit) DCI indicating the resources used to transmit configuration information regarding the procedure for requesting system information. For example, the PDCCH resources 659 may include a DCI indicating the resources 651 as carrying the OD-SI procedure configuration. In some aspects, the DCI may indicate, for the configuration information regarding the procedure for requesting system information, one or more of a frequency resource assignment (e.g., values of N_{rb,1} and N_{rb,2} that, when combined with knowledge of the channel BW and the SSB BW uniquely, identify the frequency resources carrying the OD-SI procedure configuration), whether the available resources (within the SSB BW 620 or the SSB BW 670) in the PSS symbol are used (or are not used), a redundancy value (RV), a virtual resource block (VRB)-to-PRB mapping. In some aspects, DCI may indicate some configuration information regarding the procedure for requesting system information (e.g., one or more PRACH and/or WUS configuration parameters such as PRACH SCS, prach-ConfigurationIndex, ssb-perRACH-Occasion, tagValue of SIB1, etc.). Accordingly, the configuration information regarding the procedure for requesting system information may be spread across the DCI and the resources indicated by the DCI.

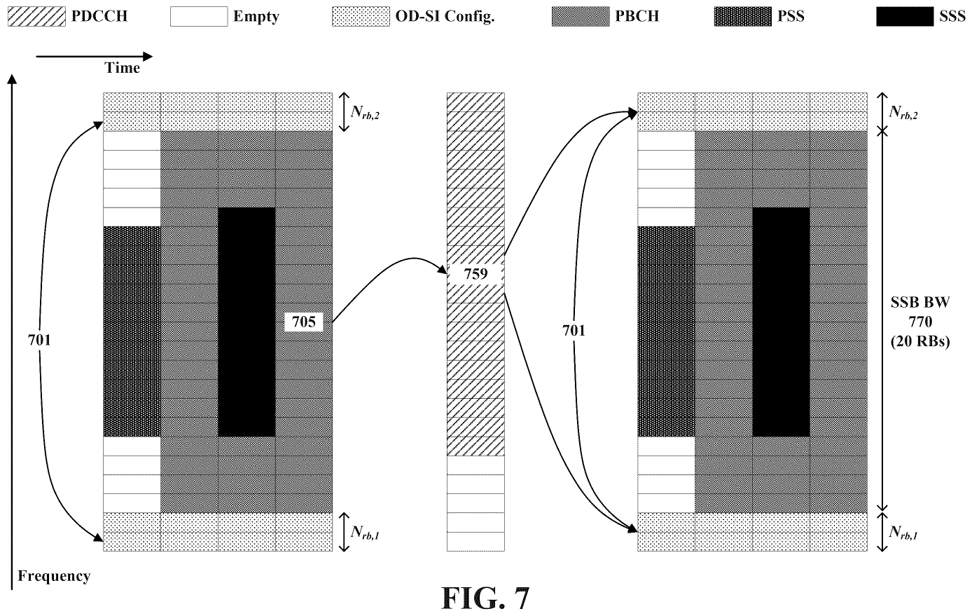

FIG. 7 illustrates a method for indicating the resources used to transmit configuration information regarding a procedure for requesting system information. The method may use a PDCCH configuration (e.g., pdcch-ConfigSIB1) for SIB1 PDCCH monitoring included in a MIB of the PBCH 705 to determine resources to monitor for DCI indicating the resources used to transmit configuration information regarding the procedure for requesting system information. For example, a MIB in PBCH 705 may indicate, via a PDCCH resource configuration, PDCCH resources 759 for indicating the resources used to transmit configuration information regarding the procedure for requesting system information (e.g., PDCCH resources that may include a DCI providing resource scheduling for an OD-SI procedure configuration).

The PDCCH resources 759 in some aspects, may include (or be used to transmit) DCI indicating the resources used to transmit configuration information regarding the procedure for requesting system information. For example, the PDCCH resources 759 may include a DCI indicating the resources 701 as carrying the OD-SI procedure configuration. In some aspects, the DCI may indicate, for the configuration information regarding the procedure for requesting system information, one or more of a frequency resource assignment (e.g., values of N_{rb,1} and N_{rb,2} that, when combined with knowledge of the channel BW and the SSB BW 770 uniquely, identify the frequency resources carrying the OD-SI procedure configuration), whether the available resources (within SSB BW) in the PSS symbol are used (or are not used), a redundancy value (RV), a virtual resource block (VRB)-to-PRB mapping. In some aspects, the values of N_{rb,1} and N_{rb,2} may be jointly indicated in a set of bits in the DCI. For a channel with a minimum channel BW (e.g., where N_{rb,1}+N_{rb,2=4}), for example, a set of three bits may be used to indicate one of five possible ordered pairs of values for (N_{rb,1}, N_{rb,2}), e.g., (0, 4), (1, 3), (2, 2), (1, 3), (4, 0) via the values 000, 001, 010, 011, 100 (or any other one-to-one mapping) with other values that the three bits may take being reserved or used for other purposes.

In some aspects, the MIB and/or the DCI may indicate some configuration information regarding the procedure for requesting system information (e.g., one or more PRACH and/or WUS configuration parameters such as PRACH SCS, prach-ConfigurationIndex, ssb-perRACH-Occasion, tagValue of SIB1, etc.). Accordingly, the configuration information regarding the procedure for requesting system information may be spread, or distributed, across the MIB, the DCI, and the resources 701 indicated by the DCI.

In some aspects, the DCI indicating the resources used to transmit configuration information regarding the procedure for requesting system information may be scrambled with a first radio network temporary identifier (RNTI) that is different from a second RNTI used to scramble DCI associated with SI (e.g., a SI-RNTI). In such aspects, the different RNTI may be used to identify the DCI as scheduling resources for the OD-SI procedure configuration. For example, in the illustration of FIG. 7, a DCI received in the PDCCH resources 759 may be either for SI or for the OD-SI procedure configuration and the scrambling RNTI may be used to determine whether a particular DCI is associated with SI or with the OD-SI procedure configuration.

A RNTI used to scramble the DCI indicating the resources used to transmit configuration information regarding the procedure for requesting system information, in some aspects, may be the same as a RNTI used to scramble DCI associated with SI (e.g., the SI-RNTI). In some such aspects, a UE may not expect to receive/monitor DCI for SI in the PDCCH resource reserved for monitoring DCI for PDSCH carrying OD-SIB1 procedure configuration such that the DCI may be identified as one of associated with SI or with the OD-SI procedure configuration based on the PDCCH resources in which it is received. For example, a DCI received via PDCCH resources 659 of FIG. 6B may be identified as being associated with the OD-SI procedure configuration based on being received in the PDCCH resources 659 despite being scrambled with the SI-RNTI, while a DCI received via PDCCH resources 759 of FIG. 7 may be identified as being associated with SI based on being received in the PDCCH resources 759 and being scrambled by the SI-RNTI. In some aspects, both DCI associated with SI and DCI associated with the OD-SI procedure configuration may be received in a same set of PDCCH resources and with a same scrambling (e.g., scrambled by a same SI-RNTI), where the DCI includes an indication of the purpose of DCI (e.g., whether it is associated with SI or OD-SI procedure configuration), e.g., by extending the value of a bit field in the DCI (e.g., a “System Information Indicator”) to be able to indicated that the DCI is associated with the OD-SI procedure configuration. For example, a bit field used to indicate whether the DCI is associated with SIB1 or OSI (e.g., {SIB1, OSI}) may be extended to be able to additionally identify that the DCI is associated with OD-SI procedure configuration (e.g., {SIB1, OSI, OD-SI-config}).

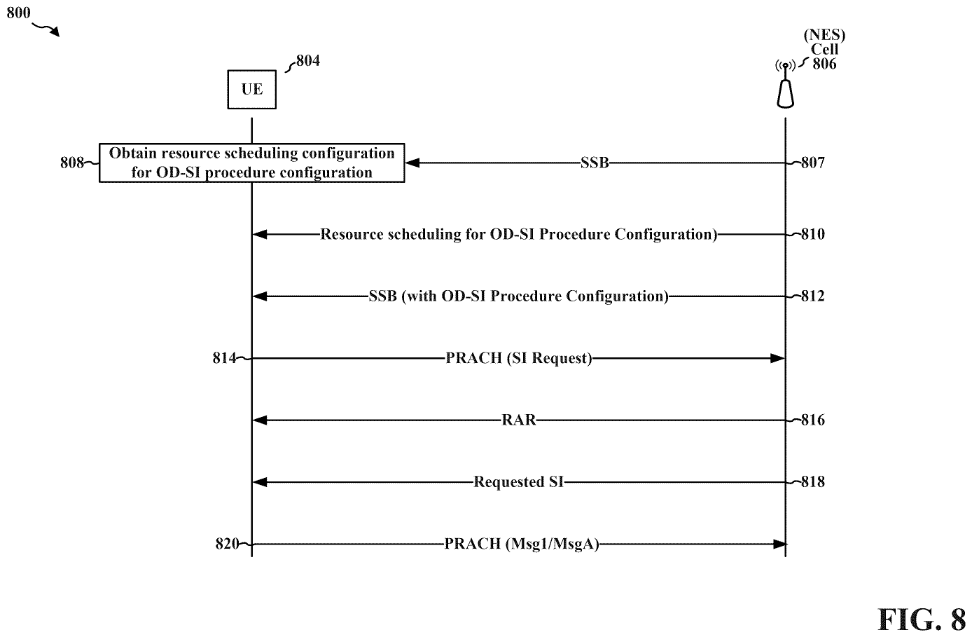

FIG. 8 is a call flow diagram 800 illustrating a method of wireless communication associated with a cell 806 providing configuration for an OD-SI request to a UE 804 in accordance with some aspects of the disclosure. While discussed in terms of a method associated with an OD-SIB1 procedure (e.g., a procedure for requesting SIB1), in some aspects, the method may be used in association with an OD-OSI or OD-SI procedure generally (e.g., a procedure for requesting SI generally). The method is illustrated in relation to an cell 806 (e.g., as an example of a network device or network node that may include one or more components of a disaggregated base station) in communication with a UE 804 (e.g., as an example of a wireless device). The cell 806, in some aspects, may be a cell, e.g., an NES cell, that does not periodically transmit SI and instead transmits SI based on an OD-SI procedure. The functions ascribed to the cell 806, in some aspects, may be performed by one or more components of a network entity, a network node, or a network device (a single network entity/node/device or a disaggregated network entity/node/device as described above in relation to FIG. 1). Similarly, the functions ascribed to the UE 804, in some aspects, may be performed by one or more components of a wireless device supporting communication with a network entity/node/device. Accordingly, references to “transmitting” in the description below may be understood to refer to a first component of the cell 806 (or the UE 804) outputting (or providing) an indication of the content of the transmission to be transmitted by a different component of the cell 806 (or the UE 804). Similarly, references to “receiving” in the description below may be understood to refer to a first component of the cell 806 (or the UE 804) receiving a transmitted signal and outputting (or providing) the received signal (or information based on the received signal) to a different component of the cell 806 (or the UE 804).

The cell 806, in some aspects, may transmit, and UE 804 may receive SSB 807 as an instance of a periodic SSB transmission associated with an NES mode of operation. The UE 804 may, at 808, obtain configuration information for resources used to schedule resources used to transmit an OD-SI procedure configuration. For example, referring to FIGS. 6B and 7, the UE may obtain configuration information for PDCCH resources 659 and PDCCH resources 759. The configuration, in some aspects, may be known (obtained based on a preconfiguration, e.g., defining the PDCCH resources 659) or obtained from a MIB (e.g., the MIB in the PBCH 705 indicating the PDCCH resources 759) in the SSB 807.

The cell 806 may transmit, and the UE 804 may receive, an indication 810 of a resource scheduling for a set of resources associated with an SSB and carrying configuration information regarding a procedure for requesting system information. The indication 810, in some aspects, may indicate a first number of resource blocks in a channel bandwidth at a higher frequency than a PBCH of, or associated with, the SSB and a second number of resource blocks in the SSB bandwidth at a lower frequency than the PBCH. In some aspects, the indication 810 may indicate whether the set of resources includes resources in a first symbol of the SSB associated with a primary synchronization signal. The indication 810, in some aspects, may include a redundancy value (RV) associated with the set of resources carrying the configuration information. In some aspects, the indication 810 may include an additional indication of a virtual resource block to physical resource block (VRB-to-PRB) mapping. The indication 810, in some aspects, may include additional configuration information regarding the procedure for requesting the system information.

For example, the indication 810 may be included in one of MIB in an SSB transmission or a DCI received in a set of monitored resources (e.g., resources indicated by the configuration information obtained at 808) as described in relation to FIGS. 6B and 7. As described in relation to FIGS. 6B and 7, a first RNTI included in the DCI including the indication 810, in some aspects, may be different from a second RNTI included in additional DCI for a transmission of additional system information. In some aspects, the first RNTI included in the DCI including the indication 810 may be the same RNTI as a second RNTI included in additional DCI for a transmission of additional system information. The DCI including the indication 810, in some aspects, may further include a value in a field to identify the DCI as indicating the set of resources carrying the configuration information, where other DCI may use the field to indicate that the other DCI is associated with one of SIB1 or OSI as described in relation to FIGS. 6B and 7.

The cell 806 may transmit, and the UE 804 may receive, an SSB transmission 812 including the configuration information regarding the procedure for requesting system information (e.g., configuration information for an OD-SI procedure or UL WUS) in the resources indicated in the indication 810. Based on the configuration information regarding the procedure for requesting system information received in the SSB transmission 812, the UE 804 may transmit, and the cell 806 may receive, a request for the system information 814 (e.g., an UL WUS, or a PRACH, associated with a request for SI).

In response to the request for the system information 814, the cell 806 may transmit, and the UE 804 may receive, a RAR 816 and the requested SI (e.g., SIB1 or OSI) 818. Based on the SI received from the cell 806, the UE 804 may transmit a PRACH message 820 (e.g., a Msg1 or a MsgA of a RACH procedure) to establish a connection with the cell 806.

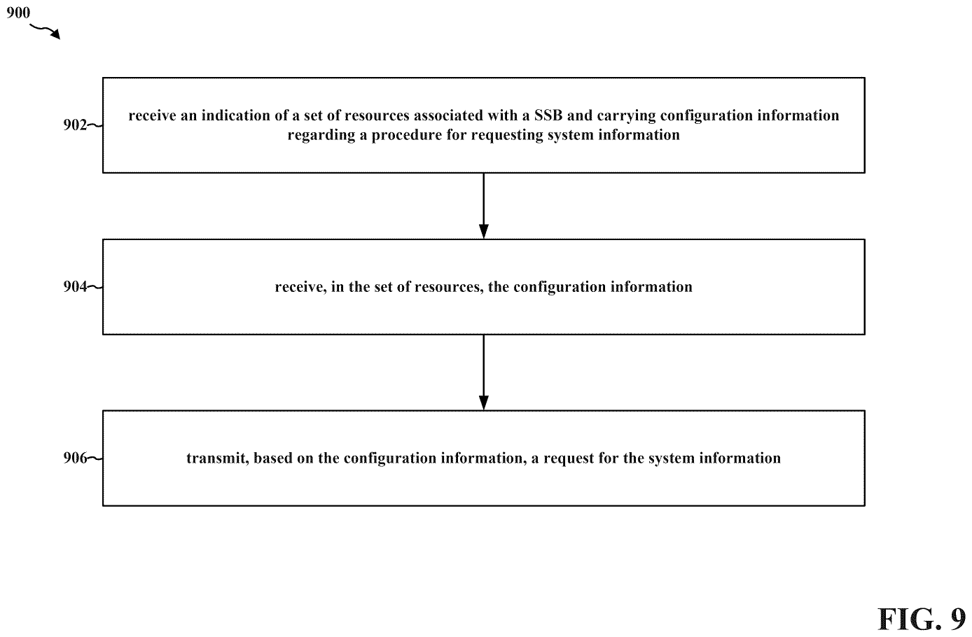

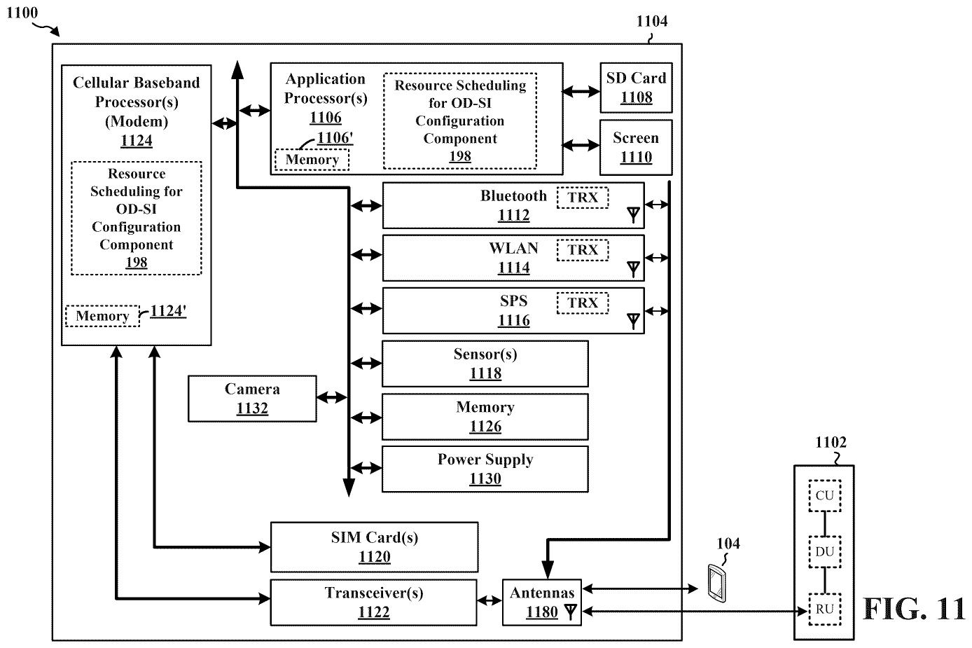

FIG. 9 is a flowchart 900 of a method of wireless communication. The method may be performed by a wireless device such as a UE (e.g., the UE 104, 804; the apparatus 1104). At 902, the UE may receive an indication of a set of resources associated with a SSB and carrying configuration information regarding a procedure for requesting system information. For example, 902 may be performed by application processor(s) 1106, cellular baseband processor(s) 1124, transceiver(s) 1122, antenna(s) 1180, and/or resource scheduling for OD-SI configuration component 198 of FIG. 11. The SSB, in some aspects, may be associated with, e.g., transmitted using, and/or received via, a first set of frequencies in an SSB bandwidth that is smaller than a channel bandwidth. In some aspects, the indication of the set of resources indicates a first number of resource blocks in a channel bandwidth at a higher frequency than a PBCH of, or associated with, the SSB and a second number of resource blocks in the SSB bandwidth at a lower frequency than the PBCH. The indication, in some aspects, further indicates whether the set of resources includes resources in a first symbol of the SSB associated with a primary synchronization signal. In some aspects, receiving the indication includes receiving an MIB transmitted via a PBCH associated with the SSB including the indication. Receiving the indication, in some aspects, may include receiving DCI including the indication. In some aspects, receiving the DCI may include receiving the DCI by monitoring one or more PDCCH candidates, or via a PDCCH, in a set of PDCCH resources, where the set of PDCCH resources are known based on a configuration of the SSB. Receiving the DCI, in some aspects, may include receiving the DCI by monitoring one or more PDCCH candidates, or via a PDCCH, in a set of PDCCH resources, where the set of PDCCH resources are known based on additional configuration information included in an MIB carried in a PBCH of, or associated with, the SSB. In some aspects, a first RNTI included in (or used to scramble) the DCI including the indication is different from a second RNTI included in (or used to scramble) additional DCI for a transmission of additional system information. In some aspects, a first RNTI included in (or used to scramble) the DCI including the indication is a same RNTI as a second RNTI included in (or used to scramble) additional DCI for a transmission of additional system information, where the DCI including the indication further includes a value in a field to identify the DCI as indicating the set of resources carrying the configuration information. The indication of the set of resources indicates one or more of: a redundancy value associated with the set of resources carrying the configuration information, an additional indication of a virtual resource block to physical resource block mapping, or additional configuration information regarding the procedure for requesting the system information. For example, referring to FIGS. 5B, 6A, 6B, 7, and 8, the UE 804 may receive the indication 810 of the resource scheduling for a set of resources associated with an SSB and carrying configuration information regarding a procedure for requesting system information (e.g., resources including, or carrying, the OD-SI configuration information 551 or the OD-SI configuration information 601, the resources 651 or the resources 701).

At 904, the UE may receive, in the set of resources, the configuration information. For example, 904 may be performed by application processor(s) 1106, cellular baseband processor(s) 1124, transceiver(s) 1122, antenna(s) 1180, and/or resource scheduling for OD-SI configuration component 198 of FIG. 11. For example, referring to FIGS. 5B, 6A, 6B, 7, and 8, the UE 804 may receive the SSB transmission 812 including the configuration information regarding the procedure for requesting system information (e.g., the OD-SI configuration information 551 or the OD-SI configuration information 601) in the resources indicated in the indication 810 (e.g., the resources 651 or the resources 701).

At 906, the UE may transmit, based on the configuration information, a request for the system information. For example, 906 may be performed by application processor(s) 1106, cellular baseband processor(s) 1124, transceiver(s) 1122, antenna(s) 1180, and/or resource scheduling for OD-SI configuration component 198 of FIG. 11. In some aspects, the system information is one of a first system information block (SIB1) or other system information (OSI). For example, referring to FIG. 8, the UE 804 may transmit the request for the system information 814.

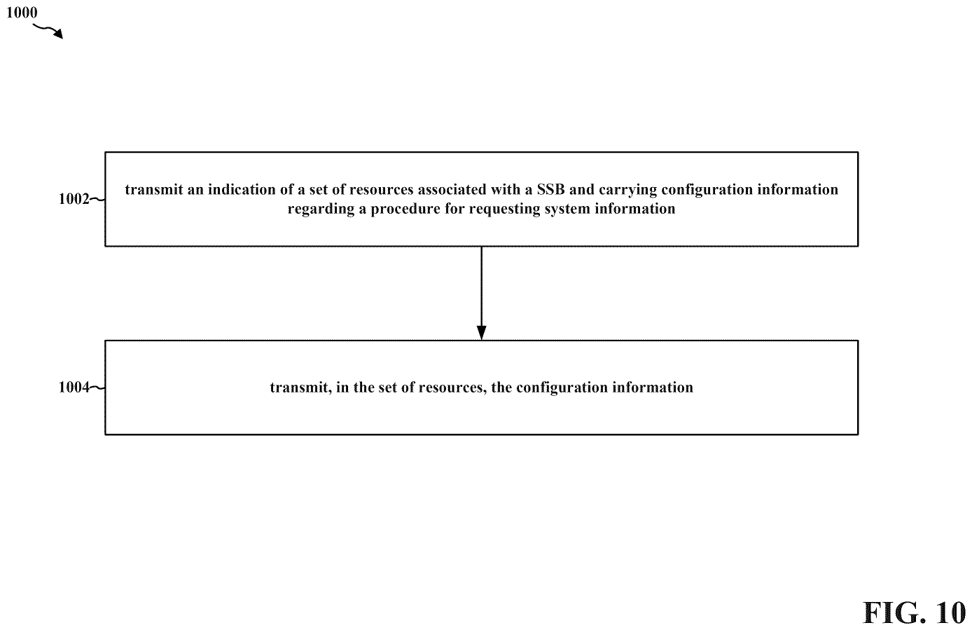

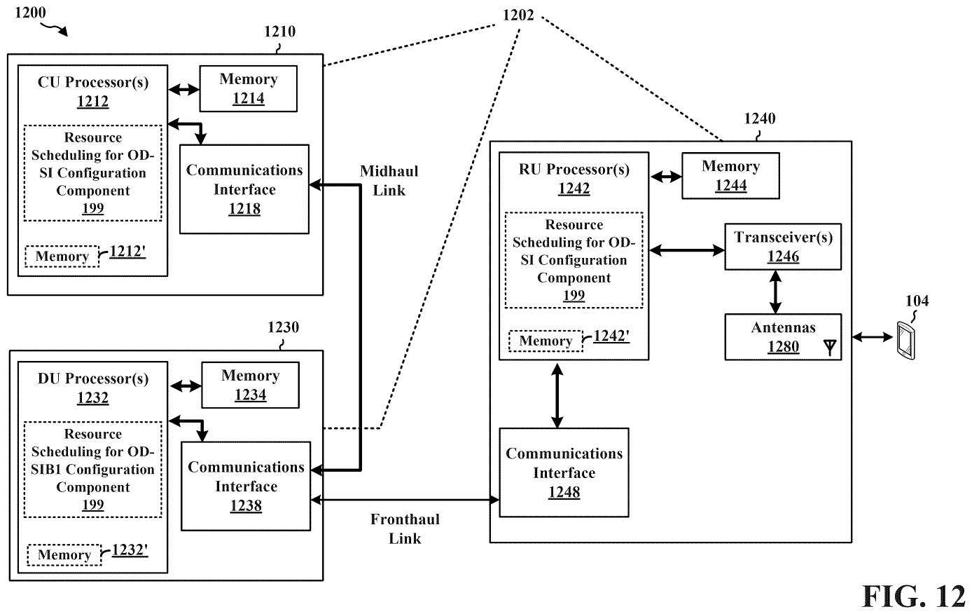

FIG. 10 is a flowchart 1000 of a method of wireless communication. The method may be performed by a network device such as a base station or NES cell (e.g., the base station 102; the cell 806; the network entity 1102, 1202). At 1002, the network device may transmit an indication of a set of resources associated with a SSB and carrying configuration information regarding a procedure for requesting system information. For example, 1002 may be performed by CU processor(s) 1212, DU processor(s) 1232, RU processor(s) 1242, transceiver(s) 1246, antenna(s) 1280, and/or resource scheduling for OD-SI configuration component 199 of FIG. 12. The SSB, in some aspects, may be transmitted using (or via) a first set of frequencies in an SSB bandwidth that is smaller than a channel bandwidth. In some aspects, the indication of the set of resources indicates a first number of resource blocks in a channel bandwidth at a higher frequency than a PBCH of, or associated with, the SSB and a second number of resource blocks in the SSB bandwidth at a lower frequency than the PBCH. The indication, in some aspects, further indicates whether the set of resources includes resources in a first symbol of the SSB associated with a primary synchronization signal. In some aspects, transmitting the indication includes transmitting an MIB via a PBCH of, or associated with, the SSB including the indication. Transmitting the indication, in some aspects, may include transmitting DCI including the indication. In some aspects, transmitting the DCI may include transmitting the DCI (via a PDCCH) in a set of PDCCH resources, where the set of PDCCH resources are known based on a configuration of the SSB. Transmitting the DCI, in some aspects, may include transmitting the DCI (via a PDCCH) in a set of PDCCH resources, where the set of PDCCH resources are known based on additional configuration information included in an MIB carried by a PBCH of, or associated with, the SSB. In some aspects, a first RNTI included in (or used to scramble) the DCI including the indication is different from a second RNTI included in (or used to scramble) additional DCI for a transmission of additional system information. In some aspects, a first RNTI included in (or used to scramble) the DCI including the indication is a same RNTI as a second RNTI included in (or used to scramble) additional DCI for a transmission of additional system information, where the DCI including the indication further includes a value in a field to identify the DCI as indicating the set of resources carrying the configuration information. The indication of the set of resources indicates one or more of: a redundancy value associated with the set of resources carrying the configuration information, an additional indication of a virtual resource block to physical resource block mapping, or additional configuration information regarding the procedure for requesting the system information. For example, referring to FIGS. 5B, 6A, 6B, 7, and 8, the cell 806 may transmit the indication 810 of the resource scheduling for a set of resources associated with an SSB and carrying configuration information regarding a procedure for requesting system information (e.g., resources including, or carrying, the OD-SI configuration information 551 or the OD-SI configuration information 601, the resources 651 or the resources 701).

At 1004, the network device may transmit, in the set of resources, the configuration information. For example, 1004 may be performed by CU processor(s) 1212, DU processor(s) 1232, RU processor(s) 1242, transceiver(s) 1246, antenna(s) 1280, and/or resource scheduling for OD-SI configuration component 199 of FIG. 12. For example, referring to FIGS. 5B, 6A, 6B, 7, and 8, the cell 806 may transmit the SSB transmission 812 including the configuration information regarding the procedure for requesting system information (e.g., the OD-SI configuration information 551 or the OD-SI configuration information 601) in the resources indicated in the indication 810 (e.g., the resources 651 or the resources 701).

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize one or more antennas 1180 for communication. The cellular baseband processor(s) 1124 communicates through the transceiver(s) 1122 via the one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the resource scheduling for OD-SI configuration component 198 may be configured to receive an indication of a set of resources associated with a SSB and carrying configuration information regarding a procedure for requesting system information, receive, in the set of resources, the configuration information, and transmit, based on the configuration information, a request for the system information. The resource scheduling for OD-SI configuration component 198 may be within the cellular baseband processor(s) 1124, the application processor(s) 1106, or both the cellular baseband processor(s) 1124 and the application processor(s) 1106. The resource scheduling for OD-SI configuration component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for receiving an indication of a set of resources associated with a synchronization signal block (SSB) and carrying configuration information regarding a procedure for requesting system information. The apparatus 1104, and in particular the cellular baseband processor(s) 1124 and/or the application processor(s) 1106, may include means for receiving, in the set of resources, the configuration information. The apparatus 1104, and in particular the cellular baseband processor(s) 1124 and/or the application processor(s) 1106, may include means for transmitting, based on the configuration information, a request for the system information. The apparatus 1104 may further include means for performing any of the aspects described in connection with the flowchart in FIG. 9, and/or performed by the UE in the communication flow of FIG. 8. The means may be the resource scheduling for OD-SI configuration component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the resource scheduling for OD-SI configuration component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, one or more antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the resource scheduling for OD-SI configuration component 199 may be configured to transmit an indication of a set of resources associated with a SSB and carrying configuration information regarding a procedure for requesting system information, and transmit, in the set of resources, the configuration information. The resource scheduling for OD-SI configuration component 199 may be within one or more processors of one or more of the CU 1210, DU 1230, and the RU 1240. The resource scheduling for OD-SI configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for transmitting an indication of a set of resources associated with a synchronization signal block (SSB) and carrying configuration information regarding a procedure for requesting system information. The network entity 1202, in some aspects, may include means for transmitting, in the set of resources, the configuration information. The network entity 1202 may further include means for performing any of the aspects described in connection with the flowchart in FIG. 10, and/or performed by the base station in the communication flow of FIG. 8. The means may be the resource scheduling for OD-SI configuration component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

Various aspects relate generally to solutions for on-demand SI for idle/inactive UEs. Some aspects relate to specifying procedures and signaling methods for UEs to obtain the configuration information for the OD-SI procedure (or the UL WUS configuration) from a cell and transmit the OD-SI request to the cell to receive the on-demand SI (e.g., on-demand SIB1 or other on-demand SI). Some aspects more specifically relate to resource scheduling for the channel carrying the configuration information for the OD-SIB1 procedure (or the UL WUS configuration). In some examples, a wireless device such as a UE may be configured to receive an indication of a set of resources associated with an SSB and carrying configuration information regarding a procedure for requesting system information, receive, in the set of resources, the configuration information, and transmit, based on the configuration information, a request for the system information. In some examples, a network device such as a base station may be configured to transmit an indication of a set of resources associated with a SSB and carrying configuration information regarding a procedure for requesting system information, and transmit, in the set of resources, the configuration information.

Particular aspects of the subject matter described in this disclosure can be implemented to realize one or more of the following potential advantages. In some examples, by providing configuration information regarding a procedure for requesting system information in an indicated set of resources associated with an SSB, the described techniques can be used to expand the deployment opportunities for NES cells and reduce, or eliminate, a dependence on a non-NES cell (e.g., a cell A).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving an indication of a set of resources associated with a synchronization signal block (SSB) and carrying configuration information regarding a procedure for requesting system information; receiving, in the set of resources, the configuration information; and transmitting, based on the configuration information, a request for the system information.

Aspect 2 is the method of aspect 1, wherein the SSB is associated with a first set of frequencies in an SSB bandwidth that is smaller than a channel bandwidth, and wherein the indication of the set of resources indicates a first number of resource blocks in a channel bandwidth at a higher frequency than a physical broadcast channel (PBCH) of the SSB and a second number of resource blocks in the SSB bandwidth at a lower frequency than the PBCH.

Aspect 3 is the method of any of aspects 1 and 2, wherein the indication further indicates whether the set of resources includes resources in a first symbol of the SSB associated with a primary synchronization signal.

Aspect 4 is the method of any of aspects 1 to 3, wherein receiving the indication comprises receiving a master information block (MIB) associated with the SSB including the indication.

Aspect 5 is the method of aspect of any of aspects 1 to 3, wherein receiving the indication comprises receiving downlink control information (DCI) including the indication.

Aspect 6 is the method of aspect 5, wherein receiving the DCI comprises receiving the DCI in a set of physical downlink control channel (PDCCH) resources, wherein the set of PDCCH resources are known based on a configuration of the SSB.

Aspect 7 is the method of aspect 5, wherein receiving the DCI comprises receiving the DCI in a set of physical downlink control channel (PDCCH) resources, wherein the set of PDCCH resources are known based on additional configuration information included in a master information block (MIB) associated with the SSB.

Aspect 8 is the method of aspect 7, wherein a first radio network temporary identifier (RNTI) included in the DCI including the indication is different from a second RNTI included in additional DCI for a transmission of additional system information.

Aspect 9 is the method of aspect 7, wherein a first radio network temporary identifier (RNTI) included in the DCI including the indication is a same RNTI as a second RNTI included in additional DCI for a transmission of additional system information, wherein the DCI including the indication further includes a value in a field to identify the DCI as indicating the set of resources carrying the configuration information.

Aspect 10 is the method of any of aspects 1 to 9, wherein the indication of the set of resources indicates one or more of: a redundancy value associated with the set of resources carrying the configuration information; an additional indication of a virtual resource block to physical resource block mapping; or additional configuration information regarding the procedure for requesting the system information.

Aspect 11 is the method of any of aspects 1 to 10, wherein the system information is one of a first system information block (SIB1) or other system information (OSI).

Aspect 12 is a method of wireless communication at a network device, comprising: transmitting an indication of a set of resources associated with a synchronization signal block (SSB) and carrying configuration information regarding a procedure for requesting system information; and transmitting, in the set of resources, the configuration information.

Aspect 13 is the method of aspect 12, wherein the SSB is transmitted using a first set of frequencies in an SSB bandwidth, and wherein the indication of the set of resources indicates a first number of resource blocks in the SSB bandwidth at a higher frequency than a physical broadcast channel (PBCH) associated with the SSB and a second number of resource blocks in the SSB bandwidth at a lower frequency than the PBCH.

Aspect 14 is the method of any of aspects 12 and 13, wherein the indication further indicates whether the set of resources includes resources in a first symbol of the SSB associated with a primary synchronization signal.

Aspect 15 is the method of any of aspects 12 to 14, wherein transmitting the indication comprises transmitting a master information block (MIB) associated with the SSB including the indication.

Aspect 16 is the method of any of aspects 12 to 14, wherein transmitting the indication comprises transmitting downlink control information (DCI) including the indication.

Aspect 17 is the method of aspect 16, wherein transmitting the DCI comprises transmitting the DCI in a set of physical downlink control channel (PDCCH) resources, wherein the set of PDCCH resources are known based on a configuration of the SSB.

Aspect 18 is the method of aspect 16, wherein transmitting the DCI comprises transmitting the DCI in a set of physical downlink control channel (PDCCH) resources, wherein the set of PDCCH resources are known based on additional configuration information included in a master information block (MIB) associated with the SSB.

Aspect 19 is the method of any of aspects 16 to 18, wherein a first radio network temporary identifier (RNTI) included in the DCI including the indication is different from a second RNTI included in additional DCI for a transmission of additional system information.

Aspect 20 is the method of any of aspects 16 to 18, wherein a first radio network temporary identifier (RNTI) included in the DCI including the indication is a same RNTI as a second RNTI included in additional DCI for a transmission of additional system information, wherein the DCI including the indication further includes a value in a field to identify the DCI as indicating the set of resources carrying the configuration information.

Aspect 21 is the method of any of aspects 12 to 20, wherein the indication of the set of resources indicates one or more of: a redundancy value associated with the set of resources carrying the configuration information; an additional indication of a virtual resource block to physical resource block mapping; or additional configuration information regarding the procedure for requesting the system information.

Aspect 22 is the method of any of aspects 12 to 20, wherein the system information is one of a first system information block (SIB1) or other system information (OSI).

Aspect 23 is an apparatus for wireless communication at a UE, comprising: at least one memory; and at least one processor coupled to the at least one memory, the at least one processor is configured to perform the method of any of aspects 1 to 11.

Aspect 24 is an apparatus for wireless communication at a UE, comprising means for performing each step in the method of any of aspects 1 to 11.

Aspect 25 is the apparatus of any of aspects 23 to 24, further comprising a transceiver configured to receive or to transmit in association with the method of any of aspects 1 to 11.

Aspect 26 is a computer-readable medium storing computer executable code at a UE, the code when executed by at least one processor causes the at least one processor to perform the method of any of aspects 1 to 11.

Aspect 27 is an apparatus for wireless communication at a network device, comprising: at least one memory; and at least one processor coupled to the at least one memory, the at least one processor is configured to perform the method of any of aspects 12 to 22.

Aspect 28 is an apparatus for wireless communication at a network device, comprising means for performing each step in the method of any of aspects 12 to 22.

Aspect 29 is the apparatus of any of aspects 27 to 28, further comprising a transceiver configured to receive or to transmit in association with the method of any of aspects 12 to 22.

Aspect 30 is a computer-readable medium storing computer executable code at a network device, the code when executed by at least one processor causes the at least one processor to perform the method of any of aspects 12 to 22.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive an indication of a set of resources associated with a synchronization signal block (SSB) and carrying configuration information regarding a procedure for requesting system information;
receive, in the set of resources, the configuration information; and
transmit, based on the configuration information, a request for the system information.

2. The apparatus of claim 1, wherein the SSB is associated with a first set of frequencies in an SSB bandwidth that is smaller than a channel bandwidth, and wherein the indication of the set of resources indicates a first number of resource blocks in the channel bandwidth at a higher frequency than a physical broadcast channel (PBCH) of the SSB and a second number of resource blocks in the SSB bandwidth at a lower frequency than the PBCH.

3. The apparatus of claim 2, wherein the indication further indicates whether the set of resources includes resources in a first symbol of the SSB associated with a primary synchronization signal.

4. The apparatus of claim 1, wherein to receive the indication, the at least one processor is configured to receive a master information block (MIB) associated with the SSB that includes the indication.

5. The apparatus of claim 1, wherein to receive the indication, the at least one processor is configured to receive downlink control information (DCI) that includes the indication.

6. The apparatus of claim 5, wherein to receive the DCI, the at least one processor is configured to receive the DCI in a set of physical downlink control channel (PDCCH) resources, wherein the set of PDCCH resources are known based on a configuration of the SSB.

7. The apparatus of claim 5, wherein to receive the DCI, the at least one processor is configured to receive the DCI in a set of physical downlink control channel (PDCCH) resources, wherein the set of PDCCH resources are known based on additional configuration information included in a master information block (MIB) associated with the SSB.

8. The apparatus of claim 7, wherein a first radio network temporary identifier (RNTI) included in the DCI that includes the indication is different from a second RNTI included in additional DCI for a transmission of additional system information.

9. The apparatus of claim 7, wherein a first radio network temporary identifier (RNTI) included in the DCI that includes the indication is a same RNTI as a second RNTI included in additional DCI for a transmission of additional system information, wherein the DCI that includes the indication further includes a value in a field to identify the DCI as indicating the set of resources that carry the configuration information.

10. The apparatus of claim 1, wherein the indication of the set of resources indicates one or more of:
a redundancy value associated with the set of resources that carry the configuration information;
an additional indication of a virtual resource block to physical resource block mapping; or
additional configuration information regarding the procedure to request the system information.

11. The apparatus of claim 1, wherein the system information is one of a first system information block (SIB1) or other system information (OSI).

12. A method of wireless communication at a user equipment (UE), comprising:
receiving an indication of a set of resources associated with a synchronization signal block (SSB) and carrying configuration information regarding a procedure for requesting system information;
receiving, in the set of resources, the configuration information; and
transmitting, based on the configuration information, a request for the system information.

13. The method of claim 12, wherein the SSB is transmitted using a first set of frequencies in an SSB bandwidth, and wherein the indication of the set of resources indicates a first number of resource blocks in the SSB bandwidth at a higher frequency than a physical broadcast channel (PBCH) associated with the SSB and a second number of resource blocks in the SSB bandwidth at a lower frequency than the PBCH.

14. The method of claim 13, wherein the indication further indicates whether the set of resources includes resources in a first symbol of the SSB associated with a primary synchronization signal.

15. The method of claim 12, wherein receiving the indication comprises receiving a master information block (MIB) associated with the SSB including the indication.

16. The method of claim 12, wherein receiving the indication comprises receiving downlink control information (DCI) including the indication in a set of physical downlink control channel (PDCCH) resources, wherein the set of PDCCH resources are known based on a configuration of the SSB.

17. The method of claim 12, wherein receiving the indication comprises receiving downlink control information (DCI) including the indication in a set of physical downlink control channel (PDCCH) resources, wherein the set of PDCCH resources are known based on additional configuration information included in a master information block (MIB) associated with the SSB.

18. The method of claim 12, wherein the indication of the set of resources indicates one or more of:
a redundancy value associated with the set of resources carrying the configuration information;
an additional indication of a virtual resource block to physical resource block mapping; or
additional configuration information regarding the procedure for requesting the system information.

19. An apparatus for wireless communication at a network device, comprising:
at least one memory; and
at least one processor coupled to the at least one memory and, based at least in part on information stored in the at least one memory, the at least one processor is configured to:
transmit an indication of a set of resources associated with a synchronization signal block (SSB) and carrying configuration information regarding a procedure for requesting system information; and
transmit, in the set of resources, the configuration information.

20. The apparatus of claim 19, wherein the SSB is associated with a first set of frequencies in an SSB bandwidth that is smaller than a channel bandwidth, and wherein the indication of the set of resources indicates a first number of resource blocks in the channel bandwidth at a higher frequency than a physical broadcast channel (PBCH) of the SSB and a second number of resource blocks in the SSB bandwidth at a lower frequency than the PBCH.

21. The apparatus of claim 20, wherein the indication further indicates whether the set of resources includes resources in a first symbol of the SSB associated with a primary synchronization signal.

22. The apparatus of claim 19, wherein to transmit the indication, the at least one processor is configured to transmit a master information block (MIB) associated with the SSB that includes the indication.

23. The apparatus of claim 19, wherein to transmit the indication, the at least one processor is configured to transmit downlink control information (DCI) that includes the indication.

24. The apparatus of claim 23, wherein to transmit the DCI, the at least one processor is configured to transmit the DCI in a set of physical downlink control channel (PDCCH) resources, wherein the set of PDCCH resources are known based on a configuration of the SSB.

25. The apparatus of claim 23, wherein to transmit the DCI, the at least one processor is configured to transmit the DCI in a set of physical downlink control channel (PDCCH) resources, wherein the set of PDCCH resources are known based on additional configuration information included in a master information block (MIB) associated with the SSB.

26. The apparatus of claim 25, wherein a first radio network temporary identifier (RNTI) included in the DCI that includes the indication is different from a second RNTI included in additional DCI for a transmission of additional system information.

27. The apparatus of claim 25, wherein a first radio network temporary identifier (RNTI) included in the DCI that includes the indication is a same RNTI as a second RNTI included in additional DCI for a transmission of additional system information, wherein the DCI that includes the indication further includes a value in a field to identify the DCI as indicating the set of resources that carry the configuration information.

28. The apparatus of claim 19, wherein the indication of the set of resources indicates one or more of:
a redundancy value associated with the set of resources that carry the configuration information;
an additional indication of a virtual resource block to physical resource block mapping; or
additional configuration information regarding the procedure to request the system information.

29. The apparatus of claim 19, wherein the system information is one of a first system information block (SIB1) or other system information (OSI).

30. A method of wireless communication at a network device, comprising:
transmitting an indication of a set of resources associated with a synchronization signal block (SSB) and carrying configuration information regarding a procedure for requesting system information; and
transmitting, in the set of resources, the configuration information.
